(19) United States
(12) Patent Application Publication
(10) Pub. No.: US 2019/0305431 A1
(43) Pub. Date: Oct. 3, 2019

(54) Antenna System and Wireless Communication Device having One or More Bridge Circuits with a Mechanical Mounting Structure

(71) Applicant: Motorola Mobility LLC, Chicago, IL (US)

(72) Inventors: Md Rashidul Islam, Lombard, IL (US); Mohammed Abdul-Gaffoor, Palatine, IL (US); William Groves, Naperville, IL (US); Ngee Lee, Park Ridge, IL (US)

(21) Appl. No.: 15/944,726

(22) Filed: Apr. 3, 2018

(51) Int. Cl. H01Q 9/04; H01Q 1/24

(52) U.S. Cl. CPC H01Q 9/0442; H01Q 1/38; H01Q 1/243

(57) ABSTRACT

The present application provides an antenna system, which includes a conductive ground structure, and one or more arms. Each arm has two ends and a conductive path between the two ends. A first one of the two ends of the arm is coupled to the conductive ground structure, where from the first end and along the conductive path, the arm extends along a side edge of the conductive ground structure forming a slot, and continues beyond an end of the conductive ground structure a distance away from the conductive ground structure. The antenna system further includes one or more bridge circuits on a circuit substrate. Each bridge circuit selectively electrically couples one of the one or more arms to the conductive ground structure across the corresponding slot, formed there between, at a respective point along the corresponding conductive path of the one of the one or more arms. Each of the one or more bridge circuits are associated with a mechanical mounting structure for coupling at least one of the conductive ground structure or the one of the one or more arms to the circuit substrate.

### FIELD OF THE APPLICATION

The present disclosure relates generally to antenna systems or electronic devices with an antenna, and more particularly, antenna systems having conductive structures with one or more selective ground couplings.

### BACKGROUND

Electronic devices, such as smartphones, are increasingly supporting more capabilities in instances where managing the overall size of the device is a concern. As part of an overall increase in capabilities, the electronic devices, such as smartphones, are increasingly being expected to support more types of communications and/or more extensive forms of existing types of communications, simultaneously or otherwise, which support an increasing number and breadth of frequencies and/or have communication conditions that provide for the inclusion of multiple detectable signal paths. Examples of communications being increasingly supported include cellular voice and data type communications, satellite GPS type communications, Bluetooth ad hoc peer to peer type communications, Wi-Fi wireless packet data type communications, etc. Examples of more extensive forms of existing types of communications include additional support for carrier aggregation, diversity, beamforming, and MIMO (multiple-input and multiple-output).

The increasing support of communications has resulted in a larger number of electromagnetic radiating/receiving elements being included as part of an antenna system, that needs to be accommodated in smaller and ever more crowded space, and/or radiating/receiving elements that can be tuned to function alternatively and/or simultaneously across multiple sets of frequencies.

The specific frequencies supported by a particular radiating/receiving structure is largely impacted by the electrical geometries, (i.e. size and shapes), associated with the conductive structure. The geometries which affect performance across one or more sets of frequencies can be impacted by an actual size or shape of the structure, or effective geometries, where types of materials and associated components may affect the apparent electrical geometries of the structure. In order for a radiating/receiving element to function alternatively and/or simultaneously across different sets of frequencies, the effective electrical geometries can be managed through the selective coupling of elements related to the radiating/receiving structures, which can result in better or worse tuning relative to each of one or more sets of frequencies.

Structure that might facilitate alternative geometries and the mechanisms for a selective adjustment between the different apparent electrical geometries can often require additional space within the device, where the available space is already a precious resource. As such, the present innovators have recognized that it would be beneficial to include some of the circuitry that can be selectively used to support the multiple possible apparent electrical geometries, as part of the structural housing, including the mechanical mounting structures used to support the inclusion of the electrical circuits into the overall structure of the device.

### SUMMARY

The present application provides an antenna system for use in an electronic device having wireless communication capabilities. The antenna system includes a conductive ground structure, and one or more arms. Each arm has two ends and a conductive path between the two ends. A first one of the two ends of the arm is coupled to the conductive ground structure, where from the first end and along the conductive path, the arm extends along a side edge of the conductive ground structure forming a slot, and continues beyond an end of the conductive ground structure a distance away from the conductive ground structure. The distance between the end of the conductive ground structure and the corresponding conductor path of the respective one of the one or more arms encompasses an area forming a loop which is internal to the antenna system. The antenna system further includes one or more bridge circuits on a circuit substrate. Each bridge circuit selectively electrically couples one of the one or more arms to the conductive ground structure across the corresponding slot, formed there between, at a respective point along the corresponding conductive path of the one of the one or more arms a distance away from the first one of the two ends of the one of the one or more arms that is coupled to the conductive ground structures. Each of the one or more bridge circuits are associated with a mechanical mounting structure for coupling at least one of the conductive ground structure or the one of the one or more arms to the circuit substrate.

In at least one embodiment, the selective electrical coupling of the one of the one or more arms to the conductive ground structure via the respective bridge circuit is used to selectively tune the one of the one or more arms for alternative use in radiating or receiving each of two different sets of electromagnetic signal frequencies.

In at least a further embodiment, the mechanical mounting structure includes a first mechanical mount, which couples the conductive ground structure to the circuit substrate, and a second mechanical mount, which couples the one of the one or more arms to the circuit substrate. In at least a still further embodiment, the conductive ground structure is included as part of the circuit substrate.

The present application further provides a wireless communication device, which includes a controller, a transceiver that is coupled to the controller, and an antenna system that is coupled to the transceiver. The antenna system has a conductive ground structure, and one or more arms. Each arm has two ends and a conductive path between the two ends. A first one of the two ends of the arm is coupled to the conductive ground structure, where from the first end and along the conductive path, the arm extends along a side edge of the conductive ground structure forming a slot, and continues beyond an end of the conductive ground structure a distance away from the conductive ground structure. The distance between the end of the conductive ground structure and the corresponding conductor path of the respective one of the one or more arms encompasses an area forming a loop which is internal to the antenna system. The antenna system further has one or more bridge circuits. Each bridge circuit selectively electrically couples one of the one or more arms to the conductive ground structure across the corresponding slot, formed there between, at a respective point along the corresponding conductive path of the one of the one or more arms a distance away from the first one of the two ends of the one of the one or more arms that is coupled to the conductive ground structures. Each of the one or more bridge circuits are associated with a mechanical mounting structure for coupling one of the conductive ground structure or the one of the one or more arms to a circuit substrate.

These and other features, and advantages of the present disclosure are evident from the following description of one or more preferred embodiments, with reference to the accompanying drawings.

### BRIEF DESCRIPTION OF THE DRAWINGS

FIG. 1 is a front view of an exemplary wireless communication device;

FIG. 2 is a back view of the exemplary wireless communication device;

FIG. 3 is a partial front schematic view of an exemplary communication device including a conductive ground structure, such as a device with a housing having a plurality of arms integrated as part of the housing for forming a loop antenna structure;

FIG. 4 is a block diagram of portions of an exemplary antenna system having at least one bridge circuit with a mechanical mounting structure;

FIG. 5 is a partial perspective view of a portion of an exemplary antenna system with bridge circuit and mechanical mounting structure, such as one or more screw bosses;

FIG. 6 is a partial side plan view of a portion of an exemplary antenna system with bridge circuit and mechanical mounting structure, such as the one or more screw bosses, illustrated in FIG. 5;

FIG. 7 is a partial cross-sectional side plan view of a portion of an exemplary antenna system with bridge circuit and mechanical mounting structure, such as one or more clips;

FIG. 8 is a partial cross-sectional side plan view highlighting a still further exemplary clip;

FIG. 9 is a schematic view of an exemplary bridge circuit with selective electrical coupler;

FIG. 10 is a schematic view of a further exemplary bridge circuit with selective electrical coupler;

FIG. 11 is a partial cross sectional perspective view of an exemplary coupling including distributed capacitance; and

FIG. 12 is a partial schematic view of the exemplary distributed capacitance illustrated in FIG. 11.

### DETAILED DESCRIPTION OF THE PREFERRED EMBODIMENT(S)

While the present application is susceptible of embodiment in various forms, there is shown in the drawings and will hereinafter be described presently preferred embodiments with the understanding that the present disclosure is to be considered an exemplification and is not intended to limit the invention to the specific embodiments illustrated. One skilled in the art will hopefully appreciate that the elements in the drawings are illustrated for simplicity and clarity and have not necessarily been drawn to scale. For example, the dimensions of some of the elements in the drawings may be exaggerated relative to other elements with the intent to help improve understanding of the aspects of the embodiments being illustrated and described.

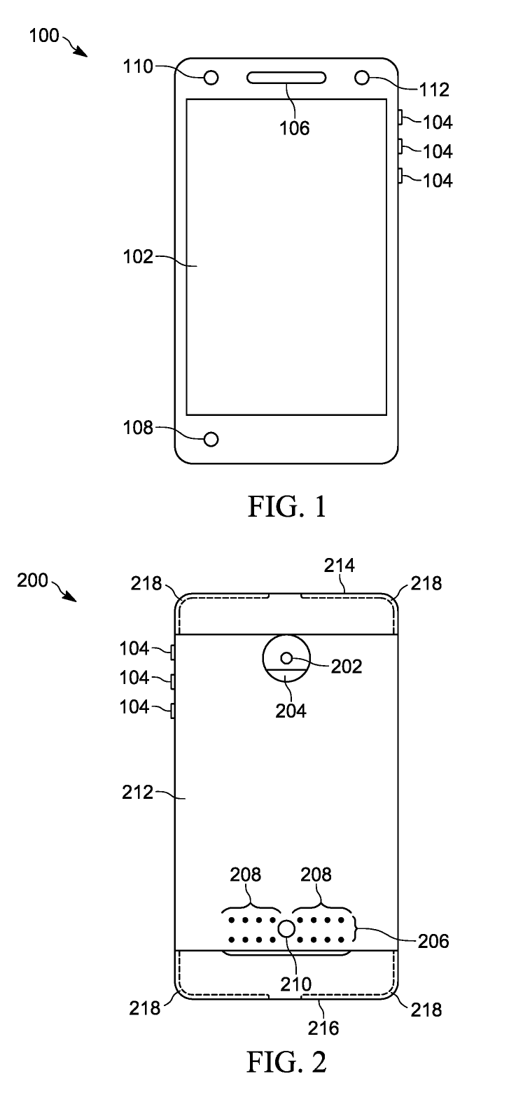

FIG. 1 illustrates a front view of an exemplary wireless communication device 100, such as a wireless communication device. While in the illustrated embodiment, the type of wireless communication device shown is a radio frequency cellular telephone, other types of devices that include wireless radio frequency communication capabilities are also relevant to the present application. In other words, the present application is generally applicable to wireless communication devices beyond the type being specifically shown. A couple of additional examples of suitable wireless communication devices that may additionally be relevant to the present application in the incorporation and management of an antenna as part of the housing can include a tablet, a laptop computer, a desktop computer, a netbook, a cordless telephone, a selective call receiver, a gaming device, a personal digital assistant, as well as any other form of wireless communication device that might be used to manage wireless communications including wireless communications involving one or more different communication standards. A few examples of different communication standards include Global System for Mobile Communications (GSM) Code Division Multiple Access (CDMA), Orthogonal Frequency Division Multiple Access (OFDMA), Long Term Evolution (LTE), Global Positioning System (GPS), Bluetooth®, Wi-Fi (IEEE 802.11), Near Field Communication (NFC) as well as various other communication standards. In addition, the wireless communication device 100 may utilize a number of additional various forms of communication including systems and protocols that support a communication diversity scheme, MIMO (multiple input multiple output), as well as carrier aggregation and simultaneous voice and data signal propagation.

In the illustrated embodiment, the radio frequency cellular telephone includes a display 102 which covers a large portion of the front facing. In at least some instances, the display can incorporate a touch sensitive matrix, that can help facilitate the detection of one or more user inputs relative to at least some portions of the display, including an interaction with visual elements being presented to the user via the display 102. In some instances, the visual element could be an object with which the user can interact. In other instances, the visual element can form part of a visual representation of a keyboard including one or more virtual keys and/or one or more buttons with which the user can interact and/or select for a simulated actuation. In addition to one or more virtual user actuatable buttons or keys, the device 100 can include one or more physical user actuatable buttons 104. In the particular embodiment illustrated, the device has three such buttons located along the right side of the device.

The exemplary wireless communication device 100, illustrated in FIG. 1, additionally includes a speaker 106 and a microphone 108 in support of voice communications. The speaker 106 may additionally support the reproduction of an audio signal, which could be a stand-alone signal, such as for use in the playing of music, or can be part of a multimedia presentation, such as for use in the playing of a movie, which might have at least an audio as well as a visual component. The speaker may also include the capability to produce a vibratory effect. However, in some instances, the purposeful production of vibrational effects may be associated with a separate element, not shown, which is internal to the device. Generally, the speaker 106 is located toward the top of the device 100, which corresponds to an orientation consistent with the respective portion of the device facing in an upward direction during usage in support of a voice communication. In such an instance, the speaker 106 might be intended to align with the ear of the user, and the microphone 108 might be intended to align with the mouth of the user. Also located near the top of the device, in the illustrated embodiment, is a front facing camera 110, and a corresponding flash 112.

FIG. 2 illustrates a back view 200 of the exemplary wireless communication device. The illustrated back view similarly has the same three physical user actuatable buttons 104, which are visible in the front view. The illustrated back view of a wireless communication device additionally includes a back side facing camera 202 with a flash 204, as well as a peripheral communication interface 206. The peripheral communication interface 206 can be used to couple a secondary device, such as a peripheral to the main device, which can be used to enhance or extend the capabilities of the device. For example in the illustrated embodiment, the peripheral communication interface 206 includes multiple conductive elements, which are intended to connect with corresponding structure in another device, such as a peripheral that can be brought within proximity and/or in contact with the other device. More specifically, in the illustrated embodiment, the peripheral communication interface 206 can include conductive pins or ports 208 that allow individual signals to be conveyed to another device having a corresponding structure, electronically. The peripheral communication interface 206 can additionally include still further structure 210, such as a registration pin, that would support proper alignment with the corresponding structure of the other device. The peripheral communication interface 206 is generally adapted for conveying electrical signals, which can include data and/or power signals.

While a particular peripheral communication interface is illustrated, one skilled in the art will appreciate that the peripheral communication interface can take alternative and/or still further forms via which data and/or power signals can be conveyed between a peripheral and a base device. In at least some instances, the structure that can support such an interface can include forms which are compatible with various industry standards, such as Universal Serial Bus (USB), Peripheral Component Interconnect Express (PCIE), Subscriber Identity Module (SIM), etc., type standards and/or interfaces.

In the particular embodiment illustrated, the back view has a rear housing portion 212, which can be comprised of a conductive material, which in at least the illustrated embodiment corresponding to at least some prior embodiments, does not extend the full length/height of the device. More specifically, the ends of the rear housing portion 212 stops short of both the top end 214 and the bottom end 216 of the device proximate the areas where multiple conductive arms 218 formed in an outer side band of the housing can extend around the areas forming one or more of the device corners, where the multiple conductive arms are each intended to function as an antenna. In at least some instances, the outer side band extends around the outer side perimeter of the device. By stopping short of the ends 214 and 216, a rear housing portion made of a conductive material can avoid extending into an area that might impact the performance of the multiple arms functioning as elements for radiating and/or receiving electromagnetic energy, such as an antenna.

The rear housing portion 212 being comprised of a conductive material can serve as and/or be a part of a conductive ground structure against which the signal traveling along a respective one of the arms can radiate. The conductive ground structure can also provide a return path for any currents associated with the wireless signaling. The distance that the respective arm extends beyond the corresponding end 214 or 216 helps serve to define an area corresponding to a loop that is internal to the antenna structure. While the conductive ground structure, in the illustrated embodiment, has been associated with an external housing surface, the conductive ground structure can also and/or alternatively be incorporated into other conductive elements, such as a circuit board substrate internal to the housing, a back side surface inlay or insert, and/or a housing for a secondary device or peripheral that might be coupled to the main device.

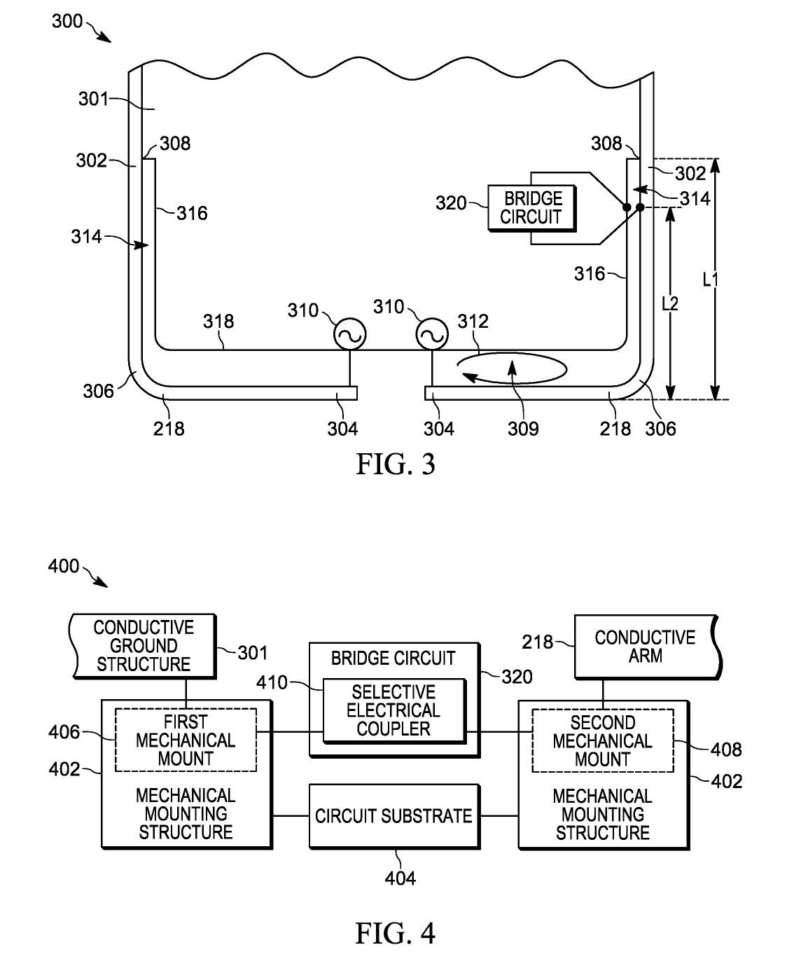

FIG. 3 illustrates a partial front schematic view 300 of an exemplary wireless communication device including a conductive ground structure 301, such as a device with a housing having a plurality of arms integrated as part of the housing for forming a loop antenna structure. Similar to the embodiment illustrated in FIG. 2, the partial front schematic view includes a pair of conductive arms 218 which extend from opposite side edges of a conductive ground structure 301 proximate one of the top or bottom ends 214 or 216 of the device. Each arm includes two ends 302 and 304, and a conductive path 306, which extends between the two ends 302 and 304 a distance away from the conductive ground structure 301. A first one 302 of the two ends of the arm 218 is coupled to the conductive ground structure 301 at a point 308 where a respective conductive side edge of the housing meets the conductive ground structure 301. The distance that the conductive path 306 of the corresponding arm extends away from the conductive ground structure 301 encloses an area 309 forming a loop which is internal to the antenna structure. The second one 304 of the two ends of the conductive arm 218 ends a distance away from the conductive ground structure 301. In the illustrated embodiment, the second one 304 of the two ends of each of the respective conductive arms 218 is coupled to a corresponding signal source 310, which supplies a signal to be transmitted to the radiating structure formed by the arrangement of each of the conductive arms relative to the conductive ground structure. The signal source 310 in combination with the respective conductive arm 218 and the conductive ground structure 301 serves to help complete the loop of the loop antenna, which has a respective current path 312.

A more precise description of the path that the current follows includes a path that takes into account the respective slot 314 formed between an arm 218 and the conductive ground structure 301, which extends along a side edge 316 of the conductive ground structure 301, and continues beyond an end 318 of the conductive ground structure. In the illustrated embodiment, the right side slot has an overall physical slot length of L1, which can affect the length of the current path, which in turn can affect the ability of the arm 218 to receive/radiate a wireless signal at one or more frequencies. While the physical slot length is often generally fixed, an effective slot length or virtual slot length can be created through the selective coupling of the corresponding one of the one or more arms 218 to the conductive ground structure 301 at different points along the length of the arm. Different slot lengths will correspondingly be respectively better or worse for radiating/receiving wireless signals relative to different sets of frequencies. For example, in at least one embodiment, one particular slot length, such as a slot length of 40 millimeters, may be more suitable for ultra-low band and low band operation on the order of 700-960 MHz. An alternative slot length, such as a slot length of 20 millimeters, may be more suitable for mid-band operation on the order of 1700-2200 MHz.

A different apparent or virtual effective slot length L2 can be created via a bridge circuit 320, which can selectively electrically couple the conductive arm 218 to the conductive ground structure 301. By adjusting an apparent or virtual effective slot length of the slot, the particular sets of frequencies that the conductive arm 218 has an ability to radiate or receive can be made selectively better or worse. In essence, the arm can be selectively tuned/detuned for different sets of frequencies by alternatively configuring the operation of the structure including adjusting the respective apparent slot length, as desired. While a single bridge circuit 320 is illustrated in FIG. 3, it is possible that more than one bridge circuit 320 can be used to create still further apparent or virtual effective slot lengths, which in turn can result in the enhanced or degraded tuning of the respective conductive arm 218 for use with one or more still further sets of frequencies. Detuning can allow for unwanted signals or spurious emissions to be reduced.

The manner in which the bridge circuit couples to one or both of the conductive ground structure 301 and/or one of the one or more conductive arms 218 can impact the amount of space required for affecting the various connections. By incorporating an electrical connection as part of the mechanical mounting, a separate exclusively electrical coupling, and the associated space that would be used therewith, may be avoided.

FIG. 4 illustrates a block diagram 400 of portions of an exemplary antenna system having at least one bridge circuit 320 with a mechanical mounting structure 402. The bridge circuit 320 is arranged on a circuit substrate 404, which in the illustrated embodiment is respectively coupled to one of the one or more conductive arms 218 and the conductive ground structure 301 via respective first 406 and second 408 mechanical mounts. The first 406 and second 408 mechanical mounts, which can form part of the mechanical mounting structure facilitate a mechanical connection between the circuit substrate 404 and the conductive ground structure 301 and the conductive arm 218. The bridge circuit 320 includes a selective electrical coupler 410. The selective electrical coupler 410 can selectively electrically couple one of the one or more conductive arms 218 to the conductive ground structure 301 via the mechanical mounting structure 402.

While the embodiment illustrated in FIG. 4 includes a mechanical mounting structure 402 including both a first 406 and a second 408 mechanical mount, in at least some instances, the conductive ground structure 301 could be included as part of the circuit substrate 404, in which case a single mechanical mount as part of the mechanical mounting structure 402 may be sufficient to facilitate a selective electrical connection between the conductive arm 218 and the conductive ground structure.

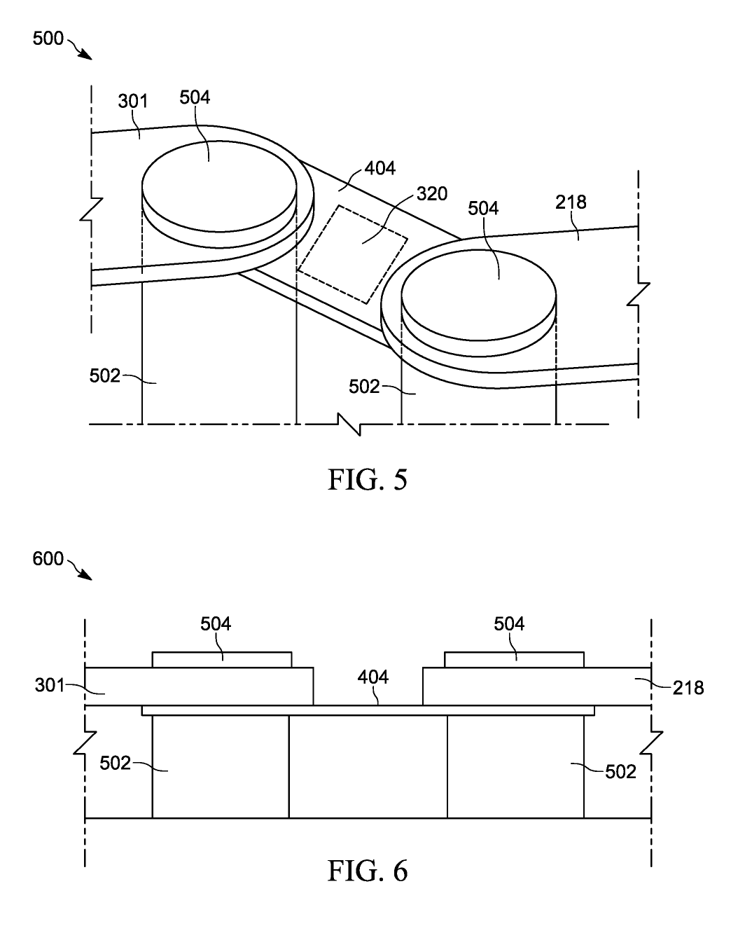

FIG. 5 illustrates a partial perspective view 500 of a portion of an exemplary antenna system with bridge circuit 320 and mechanical mounting structure 502. In the illustrated embodiment, the mechanical mounting structure 502 can include mechanical mounts in the form of one or more screw bosses. A fastener 504, such as a screw could be received by one of the screw bosses, so as to fasten a respective one of the conductive arms 218 or the conductive ground structure 301 to the circuit substrate 404. An electrical connection via the mechanical mounting could be facilitated through the use of a conductive pad and/or plated via, associated with the hole through which the fastener 504, extends. The fastener could be formed to include a conductive material. A conductive trace formed on the circuit substrate could electrically couple the bridge circuit 320 to the associated one of the conductive arm 218 or the conductive ground structure 301 via the fastener 504.

FIG. 6 illustrates a partial side plan view 600 of a portion of an exemplary antenna system with bridge circuit and mechanical mounting structure, such as the one or more screw bosses, illustrated in FIG. 5.

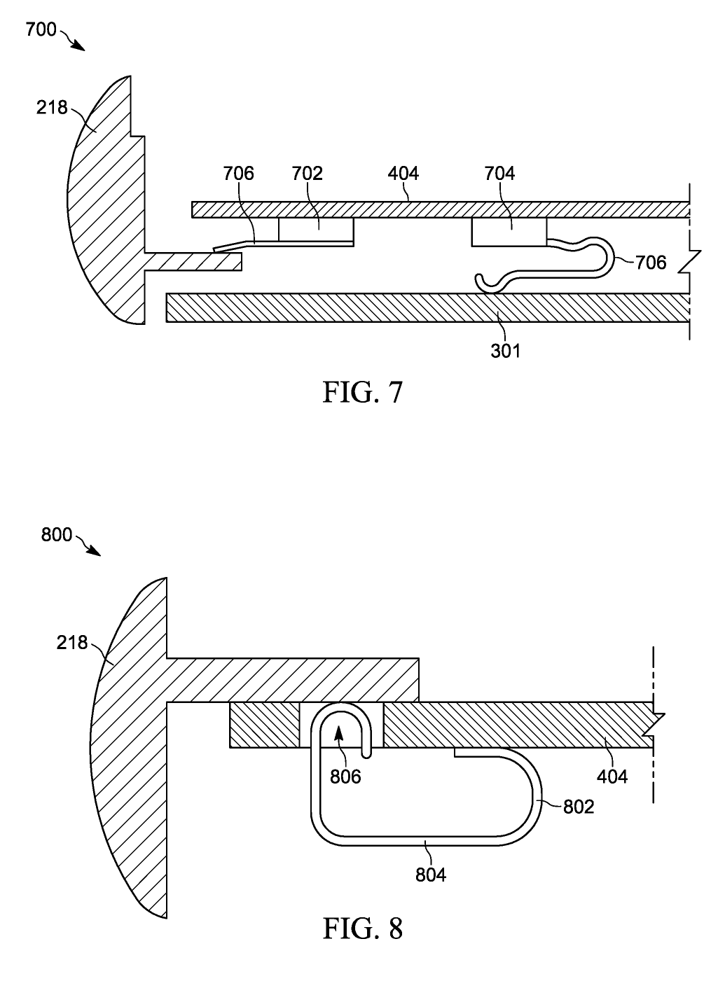

FIG. 7 illustrates a partial cross-sectional side plan view 700 of a portion of an alternative exemplary antenna system with bridge circuit and mechanical mounting structure. In the embodiment illustrated in FIG. 7, the mechanical mounting structure could additionally and/or alternatively include one or more clips 702 and/or 704. While two types of clips are illustrated, the two types of clips similarly include a cantilevered arm 706, which when engaged is deflected away from the rest position of the cantilevered arm. The deflection away from the rest position is generally under tension, which creates a bias in the deflected arm 706, so as to continuously exert an amount of force against the encroaching object, such as the conductive arm 218 or the conductive ground structure 301, while the deflection is maintained. The resulting force from the introduced bias helps the cantilevered arm 706 of the clip 702, 704 to maintain contact with the encroaching object. If the clip 702, 704 includes portions made from a material which are electrically conductive in nature, the clip can also be used to form an electrical connection between associated elements. In the illustrated embodiment, a reduced height clip 702 is coupled to one of the one or more conductive arms 218. A further clip 704 is coupled to the conductive ground structure 301.

FIG. 8 illustrates a partial cross-sectional side plan view 800 highlighting a still further exemplary clip 802. The still further exemplary clip includes a cantilevered arm 804, which can be arranged to extend through an opening 806 in the circuit substrate 404. The cantilevered arm can then engage the one of the one or more conductive arms 218, in a manner which reduces the resulting vertical distance between the corresponding conductive arm 218 and the circuit substrate 404, while maintaining contact under tension, which can support an electrical connection. By being electrically coupled to the circuit substrate 404 via the respective mounting structure, such as the clip 802, an electrical connection can be made with a bridge circuit 320 that is associated with the circuit substrate 404. In at least some instances, the circuit elements of the bridge circuit 320 are coupled to and/or are integrated with the circuit substrate 404 and the interconnections between the circuit elements are formed via conductive traces formed on the circuit substrate 404.

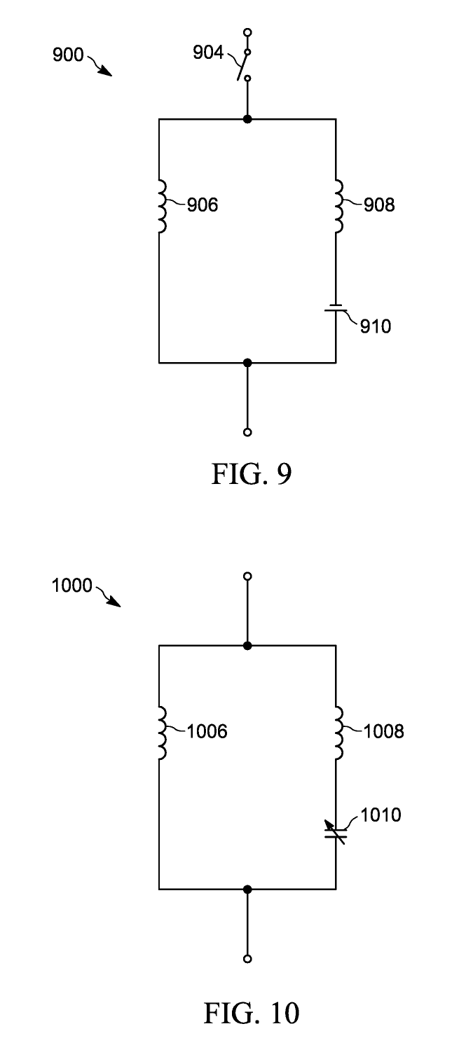

FIG. 9 illustrates a schematic view 900 of an exemplary bridge circuit with selective electrical coupler. The exemplary bridge circuit 320 with selective electrical coupler includes a switch 904, which can be used to control whether the circuit is acting as a shunt (switch closed) or not (switch open). The switch 904 is in series with the combination of an inductor 906 in parallel with the series combination of an inductor 908 and a capacitor 910. The values of the capacitor 910 and the inductors 906 and 908 can be selected to make the bridge circuit 320 appear substantially electrically equivalent at one or more frequencies of interest to the portion of the conductive arm 218 proximate the slot 316 that is being shunted by the bridge circuit 320. In at least some instances the switch can include a single pole single throw switch, a pin diode switch, a field effect transistor, or a MEMS switch. The circuit can additionally and/or alternatively include a tuning varactor diode, as an active element.

In an alternative embodiment, FIG. 10 illustrates a schematic view of a further exemplary bridge circuit with selective electrical coupler. The further exemplary bridge circuit 320 with selective electrical coupler, illustrated in FIG. 10, replaces the capacitor 910 with a variable capacitor 1010, which may allow the switch 904 to be eliminated. The variable capacitor 1010 can be used to selectively tune and detune the bridge circuit 320, so as to control the ability of the circuit to function as a shunt depending upon the frequency of the signal being transmitted or received.

While in some instances the values of the various components could be selected so as to manage the nature of the coupling for each of the various frequencies. The bridge circuit 320 can in some instances incorporate some degree of active control, so as to produce the desired effect at each frequency and/or operating mode of interest. The bridge circuit 320 can include various passive elements, such as inductors, capacitor and resistors having fixed values. The bridge circuit 320 can also include various active element, such as the switch 904, and variable value elements, such as the variable capacitor 1010. The control of the active elements can be coordinated with the current desired wireless communication operating frequencies being used with the one or more radiating structures, such as the one or more conductive arms 218, so as to enable the radiating structures to continue to operate in a desired manner. In at least some instances, an ability to adjust the apparent slot length can be used to coordinate the use of low band signals with high band signals, and in other instances an ability to adjust the apparent slot length can be used to coordinate the use of ultra low band signals with mid band frequencies. Other combinations are further possible.

Management of the active elements can be through the use of a controller, that could be implemented in the form of one or more processors, which are capable of executing one or more sets of pre-stored instructions. The controller can additionally or alternatively include state machines and/or logic circuitry. Such a controller could be incorporated as part of the overall control of the device, or could be included as part of the structure specific to the wireless modem and/or one or more transceivers. Presumably, the controller would be aware of the desired operating mode and frequencies of the various forms of wireless communications that are currently being used, and would be able to adjust the operating characteristics of the bridge circuit and included selective electrical coupler, accordingly.

The various passive elements forming the bridge circuit could be in the form of a lumped element, such as a lumped capacitor or a lumped inductor, such as a separate discrete component. The various elements could alternatively include distributed elements, such as a distributed capacitor. In some instances, the distributed element can be incorporated into the structure of the circuit substrate.

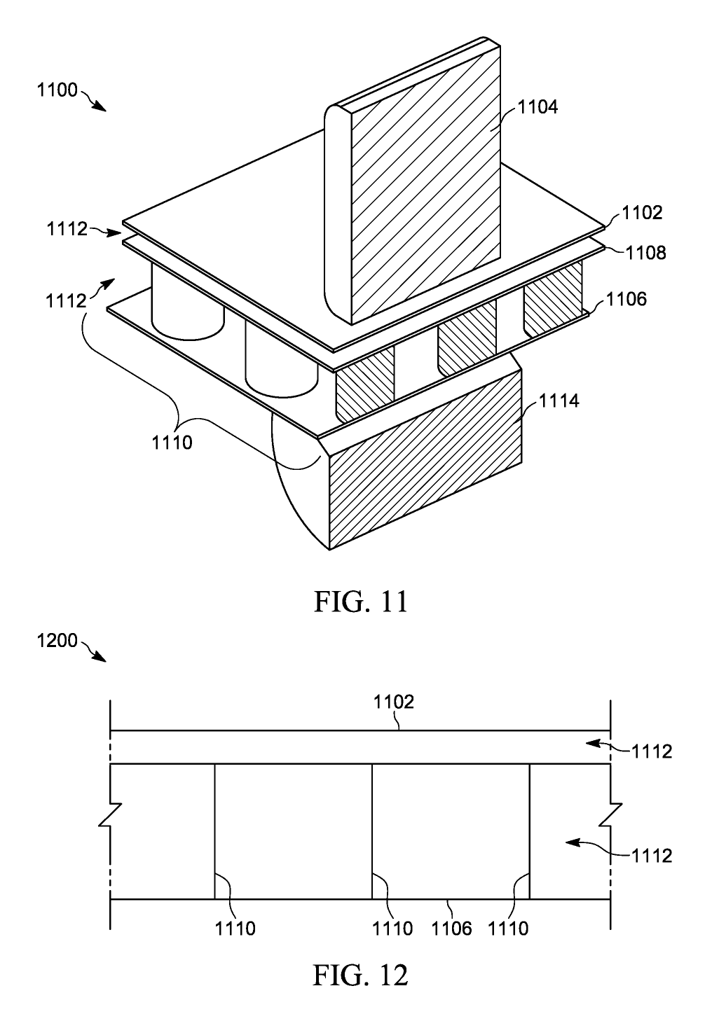

FIG. 11 illustrates a partial cross sectional perspective view 1100 of an exemplary coupling including distributed capacitance. In the illustrated embodiment, the distributed capacitance is incorporated into the structure of a circuit substrate having multiple layers. A first external layer 1102 could be coupled to a post 1104, which could support an electrical coupling, and which in turn can be coupled to other portions of the bridge circuit, and/or to one of the one or more conductive arms 218, or the conductive ground structure 301. The specific coupling between the external layer 1102 and the post could include a metal pad on the external layer via a spring contact, not shown. A second external layer 1106 could be coupled to an internal layer 1108 via an array 1110 of one or more vias. The circuit substrate could further include a dielectric material 1112 between the various layers of the circuit substrate. The second external layer could additionally be coupled to a shelf 1114, such as via an exposed metal pad and spring contact, which could support an electrical coupling, and which could similarly be coupled to other portions of the bridge circuit, and/or to one of the one or more conductive arms 218, or the conductive ground structure 301. FIG. 12 illustrates a partial schematic view 1200 of the exemplary distributed capacitance illustrated in FIG. 11.

While the preferred embodiments have been illustrated and described, it is to be understood that the invention is not so limited. Numerous modifications, changes, variations, substitutions and equivalents will occur to those skilled in the art without departing from the spirit and scope of the present invention as defined by the appended claims.

What is claimed is:

1. An antenna system for use in an electronic device having wireless communication capabilities, the antenna system comprising:
a conductive ground structure;
one or more arms, each arm having two ends and a conductive path between the two ends, where a first one of the two ends of the arm is coupled to the conductive ground structure, and where from the first end and along the conductive path, the arm extends along a side edge of the conductive ground structure forming a slot, and continues beyond an end of the conductive ground structure a distance away from the conductive ground structure, where the distance between the end of the conductive ground structure and the corresponding conductor path of the respective one of the one or more arms encompasses an area forming a loop which is internal to the antenna system; and
one or more bridge circuits on a circuit substrate, each bridge circuit selectively electrically couples one of the one or more arms to the conductive ground structure across the corresponding slot, formed there between, at a respective point along the corresponding conductive path of the one of the one or more arms a distance away from the first one of the two ends of the one of the one or more arms that is coupled to the conductive ground structures, wherein each of the one or more bridge circuits are associated with a mechanical mounting structure for coupling at least one of the conductive ground structure or the one of the one or more arms to the circuit substrate.

2. An antenna system in accordance with claim 1, wherein the respective point along the corresponding path of the one of the one or more arms that the respective bridge circuit selectively electrically couples the corresponding arm to the conductive ground structure is between the first one of the two ends of the corresponding arm and a position along the conductive path of the corresponding arm prior to continuing beyond the end of the conductive ground structure.

3. An antenna system in accordance with claim 1, wherein the selective electrical coupling for at least one of the one or more bridge circuits includes electrically coupling the corresponding one of the one or more arms to the conductive ground structure for a predetermined subset of electromagnetic signal frequencies, which are used to support the wireless communication capabilities of the electronic device.

4. An antenna system in accordance with claim 1, wherein the selective electrical coupling of the one of the one or more arms to the conductive ground structure via the respective bridge circuit is used to selectively tune the one of the one or more arms for alternative use in radiating or receiving each of two different sets of electromagnetic signal frequencies.

5. An antenna system in accordance with claim 1, wherein the mechanical mounting structure includes a screw boss.

6. An antenna system in accordance with claim 5, wherein the one of the one or more arms is coupled to the circuit substrate of the bridge circuit via the screw boss.

7. An antenna system in accordance with claim 5, wherein the conductive ground structure is coupled to the circuit substrate of the bridge circuit via the screw boss.

8. An antenna system in accordance with claim 1, wherein the mechanical mounting structure includes a clip.

9. An antenna system in accordance with claim 5, wherein the one of the one or more arms is coupled to the circuit substrate of the bridge circuit via the clip.

10. An antenna system in accordance with claim 5, wherein the conductive ground structure is coupled to the circuit substrate of the bridge circuit via the clip.

11. An antenna system in accordance with claim 1, wherein the mechanical mounting structure includes a first mechanical mount, which couples the conductive ground structure to the circuit substrate; and a second mechanical mount, which couples the one of the one or more arms to the circuit substrate.

12. An antenna system in accordance with claim 1, wherein the bridge circuit which selectively electrically couples the one of the one or more arms to the conductive ground structure across the corresponding slot includes one or more passive components.

13. An antenna system in accordance with claim 12, wherein the passive components include a lumped capacitor.

14. An antenna system in accordance with claim 12, wherein the passive components include a lumped inductor.

15. An antenna system in accordance with claim 1, wherein the bridge circuit which selectively electrically couples the one of the one or more arms to the conductive ground structure across the corresponding slot includes one or more active components.

16. An antenna system in accordance with claim 15, wherein the active components include a switch.

17. An antenna system in accordance with claim 1, wherein the conductive ground structure is included as part of the circuit substrate.

18. An antenna system in accordance with claim 1, wherein the conductive ground structure is included as part of a housing for the electronic device.

19. An antenna system in accordance with claim 1, wherein the one or more arms are included as part of an outer conductive band extending around an outer edge of a housing for the electronic device.

20. A wireless communication device comprising:
a controller;
a transceiver coupled to the controller; and
an antenna system coupled to the transceiver, the antenna system having
a conductive ground structure;
one or more arms, each arm having two ends and a conductive path between the two ends, where a first one of the two ends of the arm is coupled to the conductive ground structure, and where from the first end and along the conductive path, the arm extends along a side edge of the conductive ground structure forming a slot, and continues beyond an end of the conductive ground structure a distance away from the conductive ground structure, where the distance between the end of the conductive ground structure and the corresponding conductor path of the respective one of the one or more arms encompasses an area forming a loop which is internal to the antenna system; and
one or more bridge circuits, each bridge circuit selectively electrically couples one of the one or more arms to the conductive ground structure across the corresponding slot, formed there between, at a respective point along the corresponding conductive path of the one of the one or more arms a distance away from the first one of the two ends of the one of the one or more arms that is coupled to the conductive ground structures, wherein each of the one or more bridge circuits are associated with a mechanical mounting structure for coupling one of the conductive ground structure or the one of the one or more arms to a circuit substrate.
